(19) United States
(12) Patent Application Publication
(10) Pub. No.: US 2026/0218765 A1
(43) Pub. Date: Jul. 30, 2026

(54) ELECTROMECHANICAL DRUM BRAKE

(71) Applicant: Robert Bosch GmbH, Stuttgart (DE)

(72) Inventors: Armin Verhagen, Schwieberdingen (DE); Laszlo Boros, Ludwigsburg (DE); Simon Peter, Weil Der Stadt (DE); Xi Nowak, Bisingen (DE)

(21) Appl. No.: 19/148,837

(22) PCT Filed: Mar. 20, 2024
(86) PCT No.: PCT/EP2024/057383

§ 371 Date: Jul. 17, 2025

(30) Foreign Application Priority Data
Apr. 6, 2023 (DE) 10 2023 203 198.1

(51) Int. Cl. F16D 65/22; F16D 121/18; F16D 125/30; F16D 125/60; F16D 125/66

(52) U.S. Cl. CPC F16D 65/22; F16D 2121/18; F16D 2125/30; F16D 2125/60; F16D 2125/66

(57) ABSTRACT

An electromechanical drum brake for a motor vehicle. The drum brake includes two brake shoes and an actuator situated between the brake shoes, via which a pressure force can be applied to the brake shoes so that the brake shoes can be pressed against the drum for braking. At least one element is provided, which cooperates with the actuator and the respective brake shoe, so that with a movement of the actuator in a release direction, a tensile force can be applied to the brake shoe.

### FIELD

The present invention relates to an electromechanical drum brake for a motor vehicle. The present invention additionally relates to a motor vehicle comprising such a drum brake.

### BACKGROUND INFORMATION

In a drum brake, crescent-shaped brake shoes are electromechanically pressed against a cylindrical drum by an actuator. A braking force is thereby applied to the drum. The drum brake is often also used as a parking brake, in which the brake shoes remain on the drum for braking the motor vehicle permanently. Since the drum brake does not require brake fluid, the braking force cannot be reduced by leakage at standstill.

In the course of the increasing electrification of units in motor vehicles, the drum brake has once more become increasingly attractive since it makes it possible to do without brake fluid and the associated elaborate valve and line assembly. Such an electromechanical brake can also substantially reduce maintenance costs.

German Patent Application No. DE 10 2008 045 693 A1 describes an electromechanically operable parking brake for motor vehicles in the form of a drum brake. The drum brake has two crescent-shaped brake shoes, which are situated in a drum. A spreading element is situated between an upper end of the brake shoes, by which the brake shoes are pressed apart in order to apply the brake shoes against the drum for braking. The spreading element has a spindle drive unit, which is driven by an electric motor via a reduction gear. A float-mounted support device is situated between a lower end of the brake shoes.

Additionally, tension springs are situated between the brake shoes, by which the brake shoes are pulled back into an initial state following a braking process.

An object of the present invention is to provide an electromechanical drum brake for a motor vehicle, which has an improved releasability of the brake shoes from the drum.

The object may be achieved by an electromechanical drum brake for a motor vehicle having certain features of the present invention. Preferred specific example embodiments of the present invention are disclosed herein.

### SUMMARY

The present invention provides an electromechanical drum brake for a motor vehicle. According to an example embodiment of the present invention, the electromechanical drum brake comprises two brake shoes and an actuator situated between the brake shoes, via which a pressure force can be applied onto the brake shoes so that the brake shoes can be pressed against the drum for braking. At least one means is provided, which cooperates with the actuator and the respective brake shoe, so that with a movement of the actuator in a release direction, a tensile force can be applied to the brake shoe.

According to an example embodiment of the present invention, the brake shoes are preferably situated opposite each other in the drum. A movement in the release direction is a movement in which a braking force in the direction of the drum is reduced. Usually, a movement of the actuator in the release direction results in a space between the brake shoe and the drum. The means is preferably a structural development that may be formed via a further component, via which a tensile force may be transmitted by the actuator to the brake shoes. Due to the large surface area of the brake shoes, however, it may happen that the brake shoes freeze to the drum or remain stuck on the drum due to corrosion. In spite of the movement of the actuator in a release direction, it may happen according to the related art that the brake shoes are not released from the drum. When starting from rest, a drive torque is applied to the brake pads so that a noticeable release knock may result, in which the motor vehicle may be displaced forward or backward.

A tensile force applied by the actuator in accordance with the present invention releases the brake shoes securely already when the actuator is moved in the release direction. The tensile force is sufficient to be able to detach even brake shoes that were attached due to freezing or corrosion. This avoids a release knock when the motor vehicle is starting from rest.

According to a preferred development of the present invention, the brake shoes are movable relative to the actuator in a brake shoe movement direction oriented orthogonally to the release direction. The brake shoe movement direction is preferably also orthogonal to an axial direction of the drum. The relative movability of the brake shoes with respect to the actuator means that the latter is not firmly connected to the brake shoes. The brake shoes are thus freely able to slide upwards and downwards. This has the advantage that the brake shoes themselves can be pressed into an ideal position in the drum. This results in a homogeneous contact pressure along the entire friction surface even when the ideal position changes during operation due to thermal expansion or wear. It is thus possible that the brake shoes are also able to follow oval or eccentrically wobbling drums.

In a preferred example embodiment of the present invention, a play is provided between the means and the actuator or between the means and the respective brake shoe, which can be reduced by a movement of the actuator in the release direction. In this context, a play is understood as a structural development, via which the means applies a tensile force onto the brake shoes only after a travel of the actuator in the release direction defined by the play. As a result, a tensile force is not applied at the start of the movement of the actuator in the release direction. The brake shoes thus continue to be retractable by way of restoring springs. In the event that the force of the restoring springs is insufficient, the means applies a tensile force by which the brake shoes are securely releasable from the drum. During a regular operation of the drum brake, the function is thus not influenced by the means.

In a further preferred example embodiment of the present invention, the actuator has a mushroom head-shaped end which cooperates with a groove of the brake shoe. The groove is preferably T-shaped. The groove cooperates with the mushroom head-shaped end in such a way that in a movement in a release direction, the mushroom head-shaped end retracts the brake shoe via the groove. Thus, only small modifications are required with regard to the related art in order to achieve the object of the present invention. This makes it possible to produce a drum brake designed in this way in economical fashion.

According to an example embodiment of the present invention, the means is preferably designed as a U-shaped bracket, in which a first leg cooperates with the brake shoe and a second leg cooperates with the actuator. The U-shaped bracket connects the actuator to the brake shoe such that a tensile force can be transmitted to the brake shoe. Such a bracket has the advantage that a connection between the brake shoe and the actuator can be produced by simple means. This makes it possible to produce such a drum brake in economical fashion. There is also the possibility of retrofitting existing drum brakes accordingly.

In one advantageous development of the present invention, the actuator has a piston that is axially displaceable. The actuator may be designed for example as a spindle drive unit. There already exist many such systems so that the basic principle of the drum brake may be left unchanged.

According to an example embodiment of the present invention, the actuator is preferably designed as an S-shaped cam. An S-shaped cam, which is also known as an S-cam, is a further development of conventional drum brakes. The present invention can thus be used for such drum brakes as well, so that drum brakes of this type would also require only little modification. This makes it possible to use the present invention for such drum brakes in economical fashion.

In another advantageous example embodiment of the present invention, the actuator is developed as a wedge. Due to the wedge shape of the actuator, the brake shoes are displaced in the direction of the drum. This type of drum brake is often used for truck brakes. The ability to use the present invention for such brakes as well yields a large field of use.

According to one expedient example embodiment of the present invention, the means is developed as a cable, which can be tensioned by a rotation of an S-shaped cam in a release direction. The cable is preferably made of steel in order to be able to apply sufficient tensile force. The cable is preferably rolled up over a shaft of the actuator so that the cable can be tensioned by a rotation of the cam in a release direction. During normal operation of the drum brake, the cable is preferably detensioned so that a play is formed thereby. The cable is thus tensioned only if the brake shoes remain stuck on the drum. The cable thus forms an embodiment of low mechanical complexity. Such a development can thus be retrofitted in a simple manner on existing drum brakes having an S-shaped cam.

According to a further expedient example embodiment of the present invention, the cable is elastic. In other words, the cable has a spring constant such that the tensile force is increased merely continuously with a movement in the release direction. A more gentle detachment from the drum is thereby achieved.

The present invention additionally provides a motor vehicle having such an electromechanical drum brake. Such a motor vehicle has the above-described advantages.

Exemplary embodiments of the present invention are depicted in the figures and explained in greater detail in the description below.

### BRIEF DESCRIPTION OF THE DRAWINGS

FIG. 1 shows an illustration of a drum brake according to the related art.

FIG. 2 shows a partial illustration of a drum brake according to a first exemplary embodiment of the present invention.

FIG. 3 shows a partial illustration of a drum brake according to a second exemplary embodiment of the present invention.

FIG. 4 shows a partial illustration of a drum brake according to a third exemplary embodiment of the present invention.

FIG. 5 shows a partial illustration of a drum brake according to a fourth exemplary embodiment of the present invention.

FIGS. 6A and 6B show a partial illustration of a drum brake according to a fifth exemplary embodiment of the present invention.

### DETAILED DESCRIPTION OF EXAMPLE EMBODIMENTS

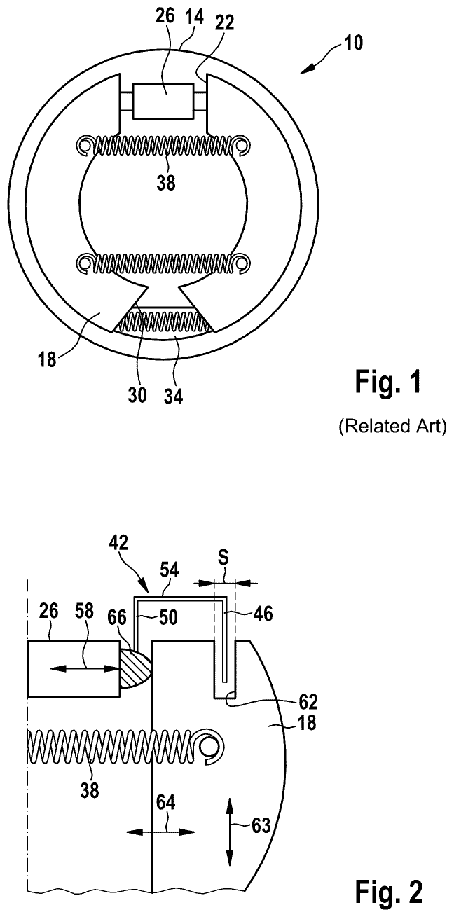

FIG. 1 shows an illustration of a drum brake 10 according to the related art. The drum brake 10 comprises a drum 14, in which two diametrically opposite crescent-shaped brake shoes 18 are situated. Between the brake shoes 18, at one first end 22 of the same, an actuator 26 is situated, via which the brake shoes 18 can be applied to the drum 14. The actuator 26 is driven via an electric motor that is not shown here. At a second end 30 of the brake shoes 18, a support element 34 is situated between the same, via which the two brake shoes 18 are connected.

The drum brake 10 additionally comprises two restoring springs 38, which are respectively connected to the two brake shoes 18. The restoring springs 38 are developed as tension springs, so that the brake shoes 18 can be pulled into a resting position following a braking operation. In the resting position, the brake shoes 18 are set apart from the drum 14.

FIG. 2 shows a partial illustration of the drum brake 10 according to a first exemplary embodiment of the present invention. In this illustration, only one side of the drum brake 10 is shown. The same reference characters are used for parts that are identical to parts in FIG. 1. In this exemplary embodiment, a U-shaped bracket 42 is additionally provided. The U-shaped bracket 42 has a first and a second leg 46, 50, which are connected to each other by a crosspiece 54. The first leg 46 engages in a groove 62 in the brake shoe formed orthogonally to a direction of movement 58 of the actuator 26 or in the axial direction of the drum brake 10. One end 66 of the second leg 50 is connected to one end of the actuator 26, so that the bracket 42 can be moved together with the actuator 26.

The groove 62 of the brake shoe 18 has a play S in the movement direction 58 of the actuator 26. As a result, in normal operation of the drum brake 10, the first leg 46 of the bracket 42 is situated in the groove 62 without making contact. Since the actuator 26 together with the bracket 42 is not firmly connected to the brake shoe 18, a movement of the brake shoe 18 is made possible in a brake shoe movement direction 63 orthogonal to a release direction 64 of the brake shoe 18. As a result, the brake shoe 18 can be pressed into an ideal position in the drum 14.

In the event that, following a movement of the actuator 26 in the release direction 64, the brake shoe 18 does not detach from the drum 14 in spite of restoring springs 38, the bracket 42, after overcoming the play S in groove 62, actively pulls the brake shoe from the drum 14. This ensures that the brake shoe 18 is detached from the drum 14. A release knock when the motor vehicle is starting from rest is thereby avoided.

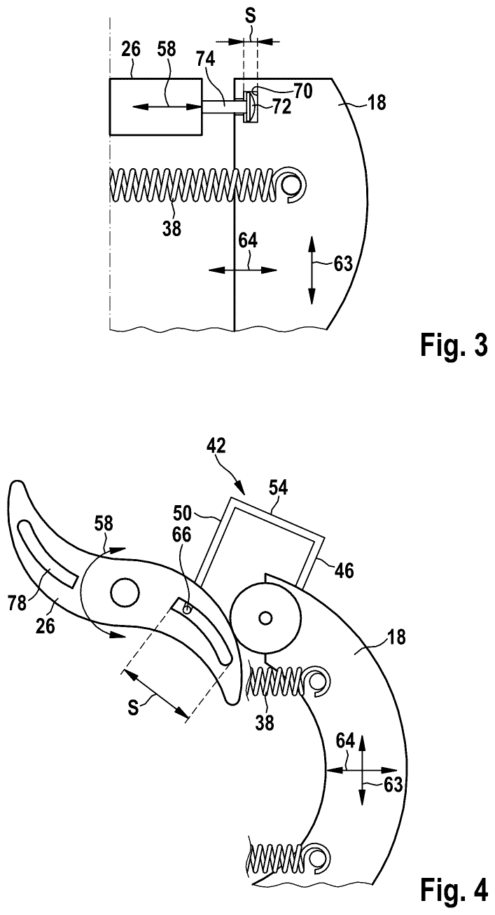

FIG. 3 shows a partial illustration of a drum brake 10 according to a second exemplary embodiment of the present invention. Here too, for the sake of simplicity, only one side of the drum brake 10 is shown. In this exemplary embodiment, the brake shoe 18 has a T-shaped groove 70 running in the axial direction to the drum brake 10. The T-shaped groove 70 is open in the direction towards actuator 26. One end 72 of an actuator piston 74 has a mushroom head shape and engages into the T-shaped groove. The mushroom head-shaped formation 72 of the actuator piston 74 is situated in the T-shaped groove 70 with play S in the movement direction 58 of the actuator 26. When the brake shoe 18 is pressed against the drum 14, an upper side of the mushroom-shaped formation 72 presses against the brake shoe 18. If the brake shoe 18 does not automatically detach from the drum 14 by way of the restoring springs 38 when the actuator piston is retracted, then the mushroom head-shaped formation 72, after overcoming a play S in the T-shaped groove 70, pulls the brake shoe 18 back with it. This ensures that the brake shoe 18 can be detached from the drum 14.

FIG. 4 shows a partial illustration of the drum brake 10 according to a third exemplary embodiment of the present invention. In this exemplary embodiment, the actuator 26 is developed as an S-shaped cam or S-cam. By rotating the cam 26 counterclockwise, a force is applied to the brake shoe 18 on account of the shape of the cam 26, so that the brake shoe 18 is pressed against the drum 14. In an opposite direction of rotation, the brake shoe 18 is released and normally pulled back into a resting position by the restoring springs 38. In this exemplary embodiment, a U-shaped bracket 42 is additionally provided, which cooperates with the actuator 26 and with the brake shoe 18.

Additionally, the cam 26 has on each side a slotted hole 78, which run along the extension direction of the cam 26. One end 66 of the second leg 50 of the bracket 42 is attached in the slotted hole 78 in such a way that the end 66 is movable along the slotted hole 78. The end of the first leg 46 is connected to the brake shoe 18 so as to be rotatable. A play S is thus implemented by the slotted hole 78, so that during normal operation the bracket 42 moves along the slotted hole 78 and applies no force to brake shoe 18. If the brake shoe 18 does not detach automatically by way of the restoring spring 38 when the actuator 26 is moved in a release direction 64, then the brake shoe 18 is pulled back by the bracket 42 after overcoming the play S in the slotted hole 78.

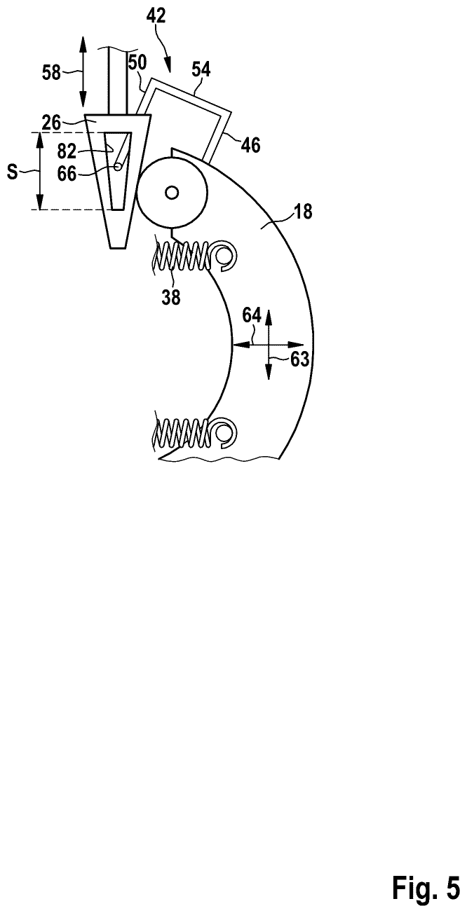

FIG. 5 shows a partial illustration of the drum brake 10 according to a forth exemplary embodiment of the present invention. In this exemplary embodiment, the actuator 26 is developed as a wedge, which by virtue of its wedge shape presses the brake shoes 18 apart. In this exemplary embodiment, a U-shaped bracket 42 is also provided, which cooperates with the brake shoe 18 and the actuator 26. A wedge-shaped opening 82 is formed in wedge 26. One end 66 of the second leg 50 is attached so as to be movable in the wedge-shaped opening 82. The end of the first leg 46 is connected to the brake shoe 18 so as to be rotatable. In the event that the brake shoe 18 does not detach from the drum 14 when the actuator 26 is moved in a release direction, a tensile force is applied to the brake shoe 18 via the bracket after a play S provided by the wedge-shaped opening 82 has been overcome, so that the brake shoe 18 detaches from the drum 14.

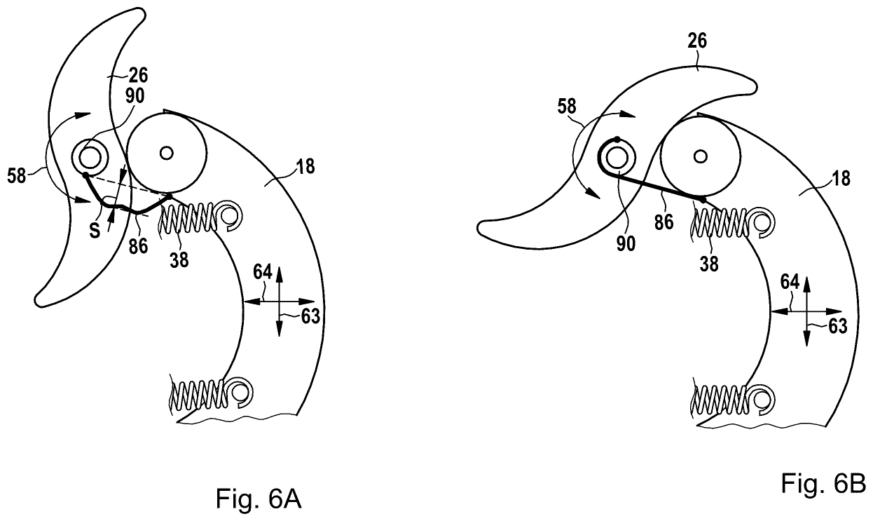

FIGS. 6A and 6B show a partial illustration of the drum brake 10 according to a fifth exemplary embodiment of the present invention. FIG. 6A shows a brake position of the S-shaped actuator 26, in which a force is applied to brake shoe 18. FIG. 6B by contrast shows a position of the actuator 26, in which the brake shoes 18 is released. In the exemplary embodiment, a cable 86 is situated between the actuator 26 and the brake shoe 18, which cooperates with both. A steel cable may be used as cable 26 for example. Cable 26 is fastened on a shaft 90 of the actuator 26. In the position shown in partial Figure a.), the cable 86 is not loaded and has some slack. This forms a play S. When the shaft 90 of the actuator 26 is rotated, the cable 86 is wound around shaft 90 so that the cable is tensioned. If, following a rotation of actuator 26 in the release direction, the brake shoe 18 does not automatically detach from the drum 14 by way of the restoring springs 38, the cable 86 is additionally tensioned so that a tensile force is applied to brake shoe 18. The brake shoe 18 is thereby detached from the drum 14.

1-11. (canceled)

12. An electromechanical drum brake for a motor vehicle, comprising:
two brake shoes;
an actuator situated between the brake shoes, via which a pressure force can be applied to the brake shoes so that the brake shoes can be pressed against the drum for braking; and
at least one element, which cooperates with the actuator and a respective brake shoe of the brake shoes, so that with a movement of the actuator in a release direction, a tensile force can be applied to the respective brake shoe.

13. The electromechanical drum brake as recited in claim 12 wherein the brake shoes are movable relative to the actuator in a brake shoe movement direction that is oriented orthogonally to the release direction.

14. The electromechanical drum brake as recited in claim 12, wherein between the element and the actuator or the element and a respective brake shoe of the brake shoes, a play is provided, which can be reduced by a movement of the actuator in the release direction.

15. The electromechanical drum brake as recited in claim 12, wherein the actuator has a mushroom head-shaped end, which cooperates with a groove of a respective brake shoe of the brake shoes.

16. The electromechanical drum brake as recited in claim 12, wherein the element is a U-shaped bracket, in which a first leg cooperates with a respective brake shoe of the brake shoes and a second leg cooperates with the actuator.

17. The electromechanical drum brake as recited in claim 12, wherein the actuator includes a piston, which is axially displaceable.

18. The electromechanical drum brake as recited in claim 12, wherein the actuator is an S-shaped cam.

19. The electromechanical drum brake as recited in claim 12, wherein the actuator is a wedge.

20. The electromechanical drum brake as recited in claim 18, wherein the element is a cable, which is tensionable by a rotation of an S-shaped cam in a release direction.

21. The electromechanical drum brake as recited in claim 20, wherein the cable is elastic.

22. A motor vehicle, comprising:
an electromechanical drum brake, including:
two brake shoes,
an actuator situated between the brake shoes, via which a pressure force can be applied to the brake shoes so that the brake shoes can be pressed against the drum for braking, and
at least one element, which cooperates with the actuator and a respective brake shoe of the brake shoes, so that with a movement of the actuator in a release direction, a tensile force can be applied to the respective brake shoe.
